(19) United States
(12) Patent Application Publication
(10) Pub. No.: US 2005/0081248 A1
(43) Pub. Date: Apr. 14, 2005

(54) Apparatus, system and method of screening broadcast signals

(76) Inventor: Ben-Zion Friedman, Jerusalem (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/673,268

(22) Filed: Sep. 30, 2003

(51) Int. Cl. H04N 7/173

(52) U.S. Cl. 725/111

(57) ABSTRACT

Apparatuses, articles, and methods are provided to screen broadcast signals during a channel locking procedure, thereby enabling fast rejection of unwanted signals and/or fast locking onto wanted signals by a broadband demodulator. The method may include determining whether to continue a channel locking procedure, by applying at least one predetermined criterion to interim data resulting from at least one act of the channel locking procedure. The method may be executed by a state machine, using a channel lock sensing mechanism.

### BACKGROUND OF THE INVENTION

Broadband demodulators, and in particular demodulators used by cable modems, may be used to connect a computer to a broadband service provider that may provide access to a computer communication network, e.g., the Internet. Cable modems may be linked to a computer via an Ethernet adapter card and an associated protocol. Since the computer network services may be provided over cable TV network coaxial cables, Internet packets, for example, may be combined with standard, e.g., analog or digital, TV programming signals. Therefore, a Cable Modem Termination System (CMTS) is required at the broadband service provider computer system (“the Head-End”), to enable functions, such as, for example, packet-to-RF conversion, routing, bridging, filtering and traffic shaping etc., to provide the end-user with Internet content, e-mail, and other computer communication services.

A cable TV network may broadcast or otherwise provide many channels to an end-user. There may be channels with no content (i.e., null channels), analog content and digital content. Digital channels may have digital TV content or data. During typical cable modem operation, the cable modem generally needs to filter out unwanted channels, such as, for example, null channels and analog content channels, and to lock onto a data channel that provides a signal carrying Internet content.

### BRIEF DESCRIPTION OF THE DRAWINGS

Embodiments of the present invention may be better understood and appreciated from the following detailed description taken in conjunction with the appended drawings, it being understood that these drawings are given for illustrative purposes only and are not meant to be limiting, wherein:

FIG. 1 is a simplified block-diagram illustrating a cable communication system that incorporates a cable modem device in accordance with exemplary embodiments of some aspects of the present invention;

FIG. 2 is a flow chart illustrating an exemplary channel locking procedure that may be adapted for use in conjunction with exemplary embodiments of the present invention;

FIG. 3 is a flow chart illustrating an exemplary process of channel verification according to some aspects of exemplary embodiments of the present invention;

FIG. 4 is a flow chart illustrating an exemplary process of QAM lock sensing according to some aspects of exemplary embodiments of the present invention; and

FIG. 5 is a schematic illustration of signal spectrum picture graphs, according to an aspect of an exemplary embodiment of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the description of embodiments of the invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts, functions, or operations leading to a desired result. These may include physical manipulations of physical quantities. Usually, though not necessarily, these quantities may take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “defining,” “calculating”, “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. These apparatuses may be specially constructed for the desired purposes, or they may comprise a general-purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

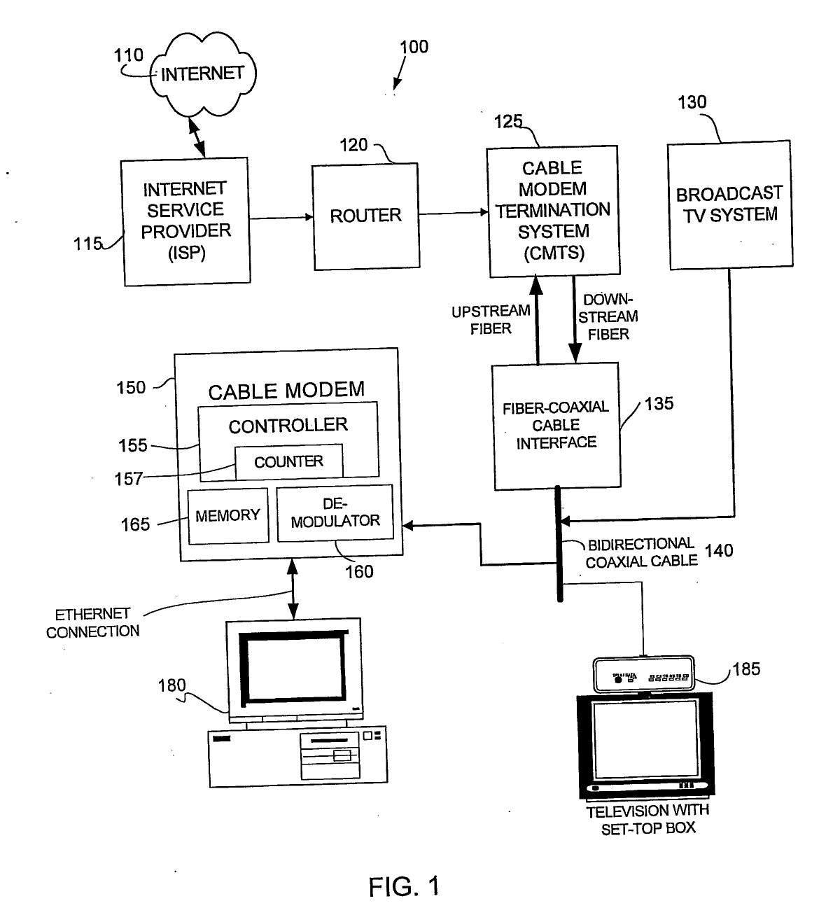

Reference is now made to FIG. 1, which schematically illustrates a cable communications system 100 incorporating a cable modem device 150 constructed and operative in accordance with exemplary embodiments of an aspect of the present invention. Computer communication network data to be received by cable modem 150 may be provided by various devices connected to a computer communication network, for example, Internet 110. The computer network data may be accessed by an Internet Service Provider (ISP) 115, which may be connected to data sources, e.g., Internet server sites. Access to content from the data sources may be enabled through a network of routers 120, as is known in the art. A Cable Modem Termination System (CMTS) 125, to enable cable modems to send and receive data packets over the Internet, may be integrated into cable communications system 100. CMTS 125 may be adapted to transmit the computer communication data as well as any other suitable type of data to users of the cable network using a downstream fiber channel. CMTS 125 may further enable users to interact with the broadband service provider using an upstream fiber channel, which may connect end users to CMTS 125. A fiber-coaxial cable interface unit 135 may act as an interface between the CMTS 125 and bidirectional coaxial cables 140, which may be used to connect customer premise equipment (CPE) to the cable network. The CMTS and/or fiber-coax interface 135 may use, for example, cable network standards, as described in “Data-Over-Cable Service Interface Specifications, Radio Frequency Interface Specification, SP-RFIv1.1-I07-010829, released Aug. 29, 2001”. Cable TV content may be broadcast to customer premise equipment (CPE), for example, a computer system 180, television set top boxes 185, etc., via bidirectional coaxial cables, as is known in the art, from broadcast TV system 130. A broadcast Television (TV) system 130, for example, of a broadband service provider (e.g., at the high-end of a cable network) may be provided in cable communications system 100, to provide broadcast TV content to cable modem users.

Cable modem 150 may use a controller 155 to operate as a state machine, for example, to demodulate incoming signals from bi-directional coaxial cable 140. Cable modem 150 may use a demodulator 160 to demodulate these incoming signals into digital data, and to modulate digital data into signals to be transmitted via bi-directional coaxial cables 140. Demodulator 160 may include an A/D converter.

Controller 155 may include a microprocessor, a computing unit, or any other suitable processing units. Controller 155 may be associated with a memory unit 165. Controller 155 may enable operation of a cable modem state machine, and may further be adapted to execute a channel lock sensing mechanism (not shown in the figure), hereinafter referred to as a “lock sense mechanism”, according to some aspects of embodiments of the present invention, as is described in detail below. Controller 155 may include a counter unit 157, which may count the number of channel locking procedure retries. Instructions and other relevant system data, operating data, network data, client data, and executable code etc. may be stored in controller 155, memory unit 165, or other relevant components. Although the scope of the present invention is not limited in this respect, controller 155 may include an application specific integrated circuit (ASIC), an application specific standard product (ASSP), a reduced instruction set circuit (RISC), a complex instruction set computer (CISC), a digital signal processor (DSP), a central processing unit (CPU), or other suitable processor. Instructions to enable controller 155 to perform methods of embodiments of the present invention, for example to operate the channel lock sensing mechanism, may be stored in memory 165, for example, in a disk or mass storage device. Such instructions may be stored, for example, in memory 165, on a floppy disk, hard disk, flash card, or other suitable storage medium. Instructions may include computer-readable code, algorithms, definitions, and calculations etc. Any other suitable computing or communication components may be used. Execution of the instructions may be performed by modem 150 or any other suitable components of modem 150 or other system components. Instructions may be embodied in hardware, software, firmware etc., or in any suitable combination of hardware, software, and/or firmware etc., in accordance with specific implementations of embodiments of the invention. For example, the instructions may be embodied in firmware, which may be stored in a read-only memory unit.

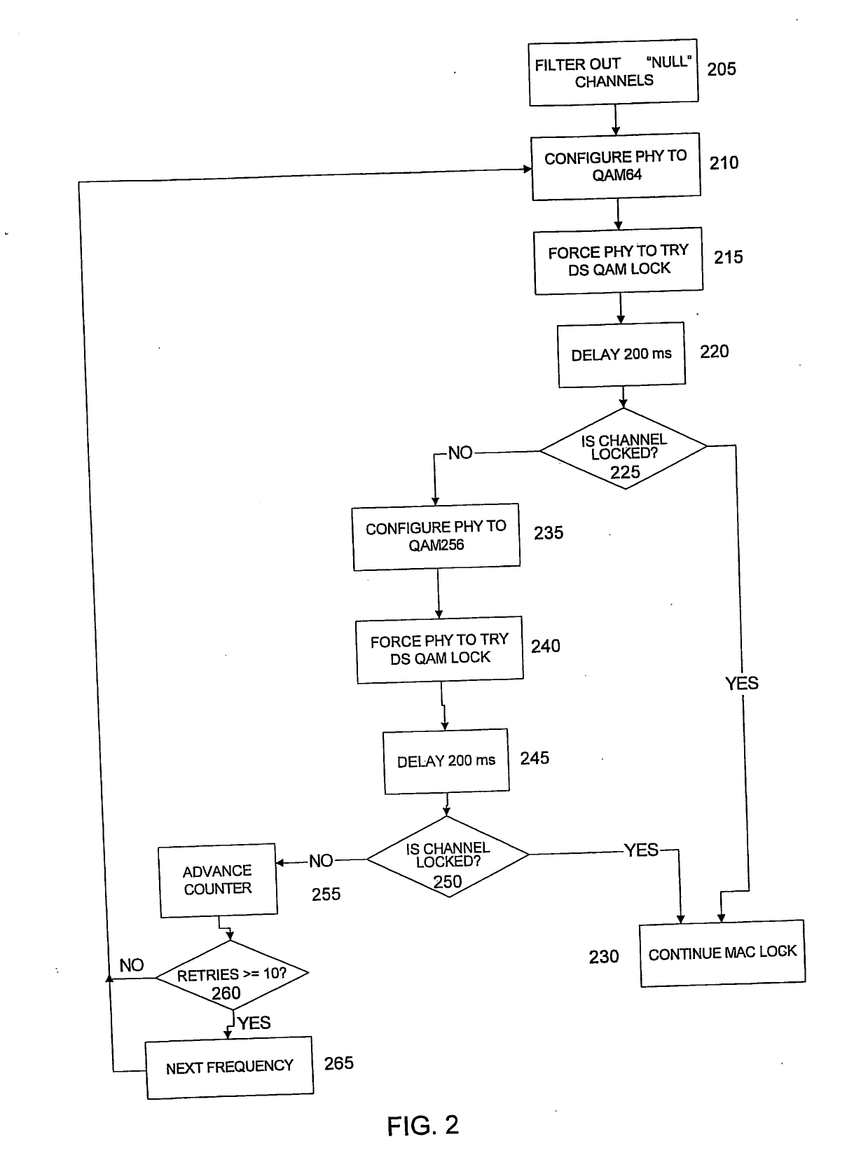

Reference is now made to FIG. 2, which illustrates an exemplary method of channel locking by a cable modem that may be adapted for use in conjunction with embodiments of the present invention, as explained in detail below. At block 205, when a signal is detected in a channel, the cable modem may filter out empty (null) channels, using, for example, Automatic Gain Control (AGC) or other known techniques. At block 210 the cable modem state machine may attempt to configure the physical protocol (PHY) of the cable device to the incoming channel. At block 215, the cable modem state machine may try to lock onto a downstream (DS) channel, which may be defined as a channel providing content or data from a service provider to an end-user. For example, the modem may attempt to verify whether an incoming signal has been modulated using a particular Quadrature Amplitude Modulation (QAM), for example, at 64 dots per constellation (QAM64), such that the signal can be appropriately demodulated. This verification of a specific QAM at which a signal has been modulated is hereinafter referred to as a “QAM check”, for example, using QAM64 and QAM 256 checks. At block 220 the modem may attempt, through a series of acts, e.g., 15 acts, hereinafter referred to as “channel locking procedure”, to lock onto the channel. The time required to complete these acts may be in the range of 200 milliseconds (ms); however other procedures may be used, requiring different acts or combinations of acts, and/or requiring different time intervals to execute the channel locking procedure. At block 225 cable modem 150 may determine, using a QAM64 check, for example, whether the channel has been locked. At block 230, if the channel has been locked, the process may continue to additional phases of the cable network communication protocol, for example, to a MAC lock phase. A standard channel locking procedure has been described in “Data-Over-Cable Service Interface Specifications”, Radio Frequency Interface Specification, SP-RFIv1.1-I07-010829, released Aug. 29, 2001.

At block 235, if the modem fails to lock onto the channel using a QAM 64 check, the modem state machine may attempt to lock onto the channel using a QAM256 (256 dots per constellation) check. At block 235 the modem may try to configure the physical protocol (PHY) to the incoming channel. At block 240, the modem may try to lock onto the downstream (DS) channel, for example, by trying to verify that the signal can be demodulated using a QAM256 check. At block 245 the modem may try, through a series of channel locking acts, to lock onto the channel. Such a locking procedure may generally require a delay of about 200 ms, however other procedures with different delay intervals may be used. At block 250 cable modem 150 may determine, using a QAM256 check, for example, whether the channel has been locked. If the channel has been locked, the process may proceed, e.g., to MAC lock, at block 230, to continue with additional phases of the communication protocol.

If the modem fails to lock onto the channel using a QAM256 check, the modem state machine may generate a “retry” command in order to lock onto a channel, for example, as may be necessary for a noisy channel. At block 255, before executing the retry command, the cable modem may query an advance counter 157, which may be located in controller 155 or elsewhere in cable modem 150. At block 260 advance counter 157 may count how many channel lock procedure retry commands have been executed. If the number, for example, is less than or equal to a preset limit, e.g., 10 retries for each QAM check, the modem may run a retry command and start the channel verification process again at block 210. If the number, for example, is greater than a preset limit, e.g., 10 retries for each QAM check, the modem state machine, at block 265, may attempt to lock onto a new channel at a different frequency. Other parameters and/or thresholds may be used.

In the above scenario, for example, 20 retry commands may be run, 10 retries for a QAM 64 check and 10 retries for a QAM 256 check, which may result in a delay of approximately 4 seconds (e.g., 20 samples of 200 milliseconds each) when rejecting a channel, before continuing to search for another channel. It similarly may require approximately 4 seconds to lock onto a channel, since the state machine of the cable modem may run through the entire locking procedure by default.

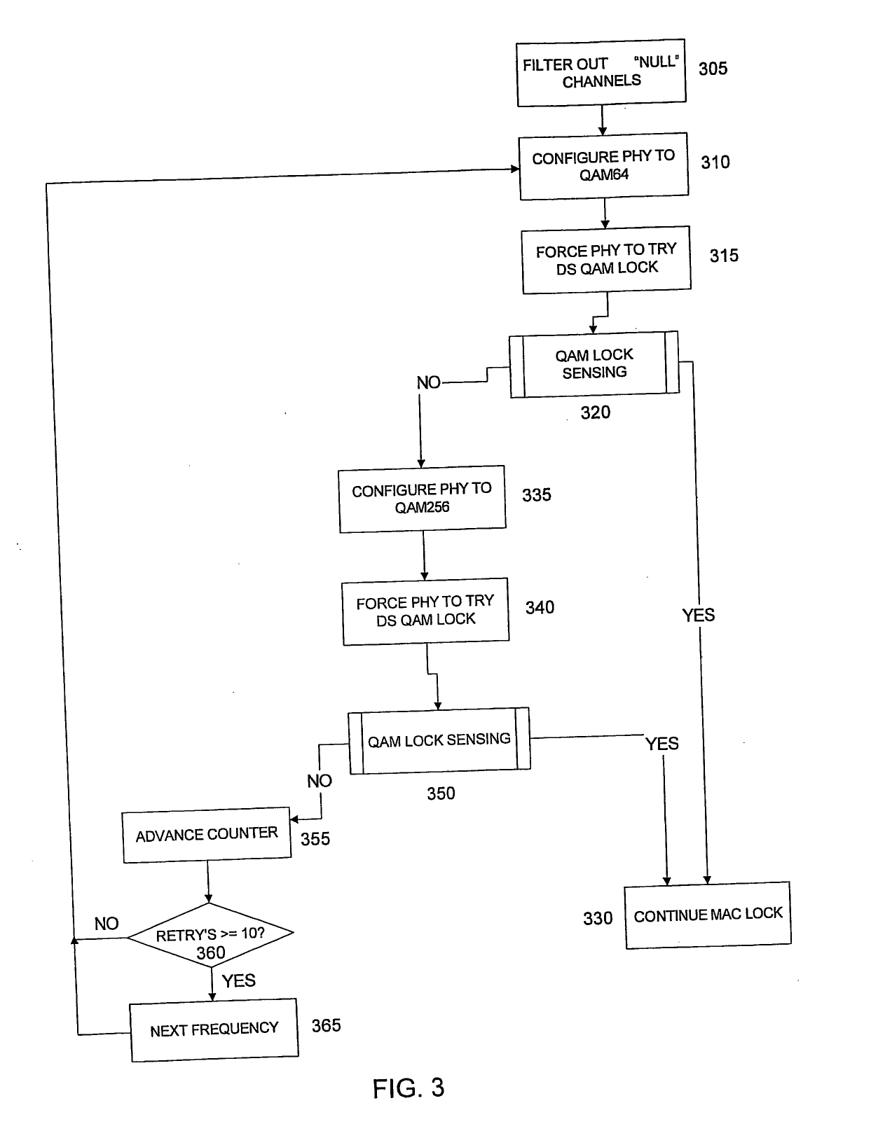

Reference is now made to FIG. 3, which is a schematic flow chart illustrating an exemplary method of channel screening in a cable communications network, according to an aspect of an embodiment of the present invention. At block 305, when a signal is detected in a channel, a cable modem state machine may filter out empty (e.g., null) channels, using, for example, Automatic Gain Control (AGC) or other known techniques. At block 310 the modem state machine may try to configure the physical protocol (PHY) onto the incoming channel. At block 315, the modem state machine may try to lock onto the downstream (DS) channel, for example, by attempting to verify that the signal can be demodulated using a specific Quadrature Amplitude Modulation (QAM) check, for example, a QAM64 check.

At block 320, during the channel locking procedure, the channel lock sensing mechanism, instructions for which may be stored in memory 165 or in any of the other hardware and/or software components of cable modem 150, may execute a QAM lock sensing act to determine whether to continue a channel locking procedure of a broadband demodulator, by applying at least one predetermined criterion to interim, temporary, or partial operational data or channel locking data from a channel, received from of at least one act or stage of the channel locking procedure, as described in detail below. This process may require a portion of the time required to complete the locking procedure, for example, approximately 50 ms of the 200 ms may be required to complete the channel locking procedure. At block 330, if the predetermined criterion is met for determining whether to continue a channel locking procedure, the channel may be determined to be a “wanted” or appropriate channel for the modem. In such a case the channel locking procedure may be continued, and additional phases of a cable modem communication protocol may be attempted, for example, a MAC lock phase may be initiated.

At block 335, if the predetermined criteria used by the lock sense mechanism to determine whether to continue the channel locking procedure are not met, the modem state machine may proceed to attempt locking onto the channel using, for example, a QAM256 check. At block 335 the modem state machine may attempt to configure the physical protocol (PHY) to the incoming channel. At block 340, the modem state machine may attempt to lock onto the downstream (DS) channel, for example, by trying to verify that the signal can be demodulated using a QAM256 check. At block 350, the cable modem's channel lock sensing mechanism may execute a QAM lock sensing act on received interim operational data or channel locking data from a channel, resulting from one or more acts in the locking procedure. This data, for example, may be analyzed by the lock sense hardware, software, and/or firmware, etc., to determine whether to continue a channel locking procedure of a broadband demodulator, by applying one or more predetermined criteria, as described in detail below. This process may require a portion of the time required to complete the locking procedure, for example, approximately 50 ms of the 200 ms required to complete the channel locking procedure. At block 330, if the predetermined criterion or criteria used by the lock sense mechanism to determine whether to continue a channel locking procedure are met, the channel may be determined to be a “wanted” or appropriate channel for the modem. In such a case the channel locking procedure may be continued, and additional phases of a cable modem communication protocol may be attempted, for example, a MAC lock phase.

At block 355, in the case where it is determined by the lock sense mechanism that the channel locking procedure should not be continued, the modem state machine may generate a retry command. At block 355, before executing the retry command, the modem state machine may query an advance counter. At block 360 the advance counter may count how many retry commands have been run. If the number is, example, less than or equal to a preset limit, the modem state machine may execute a retry command and start the channel verification process again at block 310. For example, if the number of retries executed is, for example, greater than a preset limit, for example, 10 retries for each QAM check, the modem state machine, at block 365, may attempt to lock onto a new channel at a different frequency. Other parameters or decision variables may be used.

In the above example, 20 retry commands may be run, for example, 10 retries for a QAM 64 check and 10 retries for a QAM 256 check, which may result in a delay substantially shorter than the delay required during the operation of the regular channel locking procedure. For example, a delay of approximately 1 second (e.g., 20 samples of 50 ms each) may be attained, as opposed to the 4-second delay of exemplary conventional systems as described above. In the case where the signal in the current channel is not the one that the modem requires, the modem may therefore require only approximately 1 second to reject the channel, before continuing to search for another channel or executing a retry command, thereby enabling significant time saving when rejecting an unwanted channel. In the case of a noisy channel, for example, a channel that may require a plurality of retries to lock onto, the time required by the cable modem to lock onto such a channel, according to an embodiment of the present invention, may be much shorter than the time required by conventional procedures, since each retry may be completed in significantly less time.

According to exemplary embodiments of aspects of the invention, various predetermined criteria may be applied to interim, temporary, or partial operational data from a channel to determine whether to continue a channel locking procedure of a broadband demodulator. One predetermined criterion may be based, for example, on a comparison of a symbol rate of an incoming packet with a symbol rate required by a demodulator, and defining a symbol rate match according to the results of the comparison. For example, according to some embodiments of the present invention there may be approximately 15 acts in the locking procedure, each act requiring a certain time interval, and one or more acts providing interim information relating to a channel locking procedure. In this way the symbol rate analysis may require only a portion of the time required for the state machine to complete the channel locking procedure, for example, approximately 50 ms out of approximately 200 ms for the entire channel locking procedure, thereby enabling rapid rejection, screening, or filtering out of unwanted signals when attempting to lock onto a channel. Other procedures may be used, requiring different acts or combinations of acts, and/or requiring different time intervals to executes the channel locking procedure.

Additional criteria may be provided to enable channel screening, for example, to determine channel viability, by the channel lock sense mechanism. The lock sense mechanism may analyze, for example, internal registers of the hardware block (e.g., using the PHY protocol) to determine the likelihood of a channel match. For example, an additional procedure that may be undertaken during the channel locking procedure (e.g., blocks 315, 340) may be to determine whether the signal spectrum picture of the incoming signal matches the signal spectrum picture required by the cable modem. This signal spectrum picture comparison procedure may, for example, enable differentiating between analog and digital signals, by filtering narrow bands of the channel being analyzed. Analysis of such data may aid the lock sense mechanism, during the channel locking procedure, in determining the likelihood of a channel match.

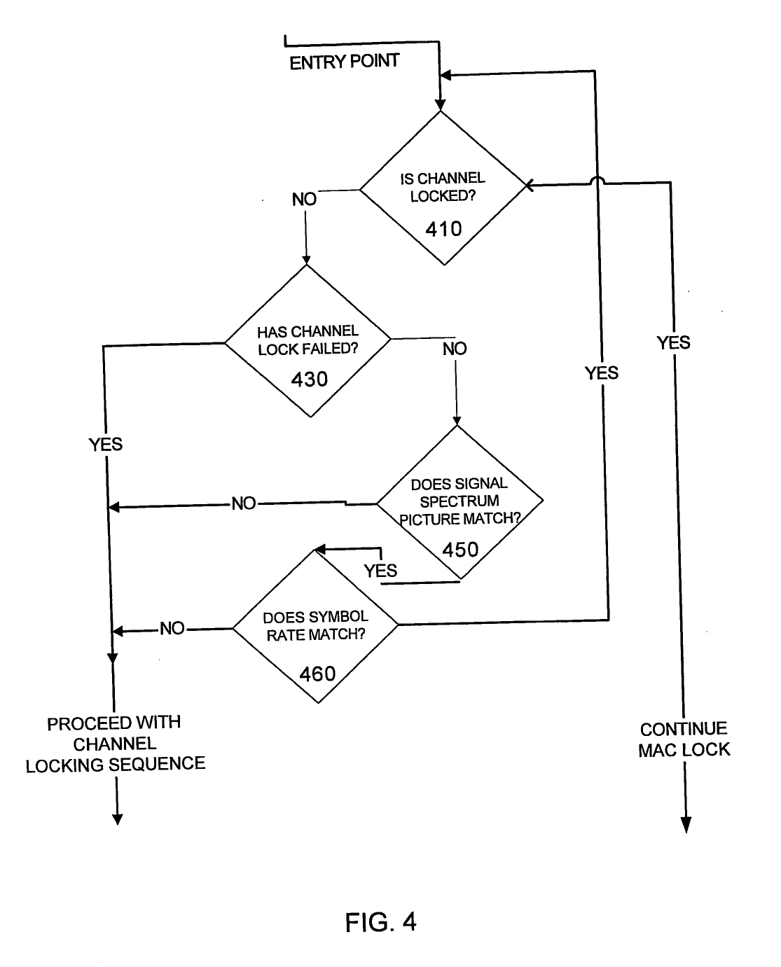

Reference is now made to FIG. 4, which is a flow chart illustrating an exemplary method of QAM lock sensing, by cable modem controller 155, according to an aspect of an embodiment of the present invention. A channel lock sense mechanism, for example, may store instructions to enable cable modem 150 to determine whether to complete a channel locking procedure, during the channel locking procedure, by applying a predetermined criterion to interim data resulting from at least one act of the channel locking procedure.

For example, at block 410, the cable modem state machine may try to lock a cable modem physical channel to the incoming channel, using the physical protocol (PHY). During the time that the channel lock sense mechanism operates, there may be no indication if the channel locking procedure has succeeded or failed, yet during this time interim data may be used to determine the chances of success of the channel being locking according to pre-determined criterion. The modem state machine may determine, during the locking procedure, whether the specific channel is locked or not, using a specific QAM check. If the channel is locked, the locking procedure may be completed, and the channel configuration process may continue with MAC lock or other channel lock acts. If the channel is not locked, at block 430 the channel lock sense mechanism may determine, during the locking procedure, whether the channel lock has failed or not. If the specific QAM check has failed, the channel lock sense mechanism may proceed with the channel locking sequence, for example, by retrying the channel lock using the same QAM check, for example, using the current QAM check, by retrying the channel lock using an alternative QAM check, or in the case where the number of retries have exceeded a pre-selected threshold, by trying to lock onto a channel using another frequency.

If the channel lock attempt using a specific QAM check has not failed, during the time in which the channel lock procedure is in progress, the channel lock sense mechanism may attempt, at block 450 to determine, using interim channel locking data, for example, whether the symbol rate of the channel matches the symbol rate required by the cable modem. If the symbol rates do not match, according to the predetermined criteria, the channel lock sense mechanism may attempt, at block 440 to retry the channel lock using the same QAM check, retry the channel lock using an alternative QAM check, or in the case where the number of retries have exceeded a pre-selected threshold, try to lock onto a channel using another frequency. If the symbol rates match, according to the predetermined criteria, the channel lock sense mechanism may, for example, attempt to determine, at block 460, whether the signal spectrum picture of the channel matches the signal spectrum picture required by the cable modem. If the signals spectrum pictures do not match, according to predetermined criteria, the channel lock sense mechanism may attempt, at block 440, to retry the channel lock. If the signal spectrum pictures match, according to the predetermined criteria, the channel lock sense mechanism may return to the entry point before block 410, to determine whether the channel is locked.

In the case where only one set of interim data is used to determine whether to continue with the channel lock procedure, for example, using symbol rate match 450, if the symbol rates match at block 450, the channel lock sense mechanism may return to the entry point before block 410, to determine whether the channel is locked using the specific QAM check. Determinations indicated by blocks 450 and 460, and any other determinations that may be made, may be executed independently, in parallel, or in any combination. In the above processes at least one criterion is provided to determine whether to continue with a channel locking procedure. Such a criterion may enable fast rejection of unwanted signals, by initiating retry commands before completion of the standard channel locking procedure.

In the case of a noisy channel, for example, a channel that may require multiple retries in order to lock on to the channel, the channel lock sense mechanism may enable significantly faster channel locking compared to channel locking mechanisms known in the art, since each of the retry operations may be completed in a shorter time interval, and therefore the cumulative time interval for the cable modem to lock onto such a noisy channel may be substantially shorter.

In the above processes, for example, guidelines may be implemented for determining whether the symbol rate of the channel matches the symbol rate required by the modem. Additionally or alternatively, guidelines may be implemented for determining whether the signal spectrum picture of the channel matches the signal spectrum picture required by the modem. For example, according to “INTERNATIONAL TELECOMMUNICATION UNION TELECOMMUNICATION STANDARDIZATION SECTOR OF ITU, (ITU-T J.83), published April 1997, entitled, SERIES J: TRANSMISSION OF TELEVISION, SOUND PROGRAMME AND OTHER MULTIMEDIA SIGNALS”, symbol rates for QAM64 may be approximately 5.056941 million symbols per second (Msps) at +/−75 parts per million (ppm), where approximately 5 ppm result from CMTS clock accuracy, and approximately 70 ppm result from client clock accuracy. Symbol rates for QAM256 may be approximately 5.360537 Msps at +/−75 parts per million (ppm), where approximately 5 ppm are taken from CMTS clock accuracy, and approximately 70 ppm are taken from client clock accuracy.

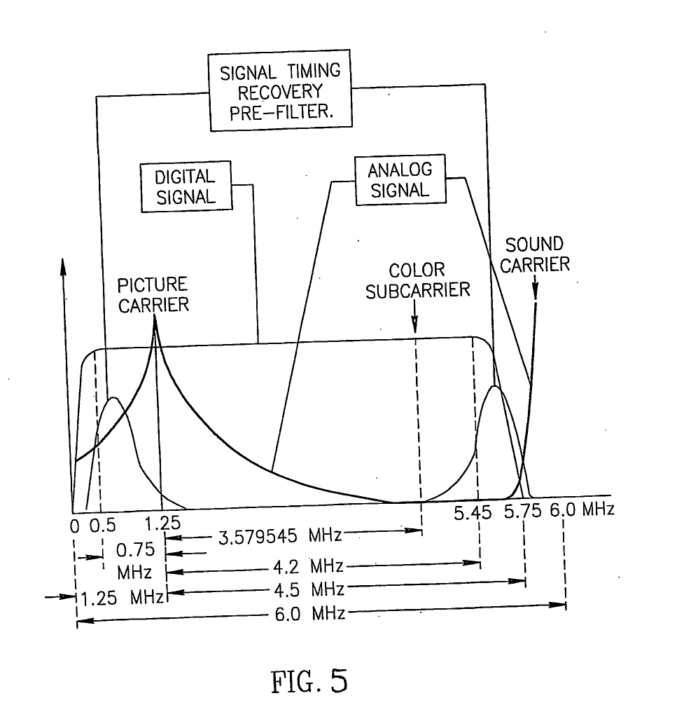

An example of a broadcast signal screening process using the signal spectrum picture of an incoming signal can be seen with reference to FIG. 5. A signal filter, for example, which may use a portion of channel to get an indication of a filter signal, may be used as a sample to differentiate between analog and digital filters. For example, a signal timing recovery pre-filter, or other types of signal filters, may be applied to the incoming signal to determine the analog or digital nature of an incoming signal. For example, the lock sense mechanism may analyze an incoming signal shape, amplitude, frequency, pulse-width, etc., to differentiate analog from digital signals. As can be seen in FIG. 5, if a signal receiver is locked on a digital signal then the timing recovery filter may output significant power. In contrast to this, while receiving an analog signal by the signal receiver, the output of the signal timing recovery filter may be significantly lower. In this way, the channel lock sense mechanism may analyze the power output during the channel locking procedure, to determine whether to continue with the channel locking procedure.

According to some aspects of embodiments of the present invention, additional interim data may be provided to the lock sense mechanism during one or more of the acts of the locking procedure. Data received may be analyzed by the lock sense mechanism hardware, software, and/or firmware etc., to further aid the lock sense mechanism in determining channel match likelihood during the physical channel (PHY) configuration.

Other functions, operations, or combinations of operations may be implemented.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method comprising:
initiating a channel locking procedure by a broadband demodulator;
applying a predetermined criterion to interim operational data resulting from an act of said channel locking procedure; and
determining whether to continue said channel locking procedure, based on said predetermined criterion.

2. The method of claim 1, wherein said act of said channel locking procedure is to determine a symbol rate of an incoming channel.

3. The method of claim 1, wherein said act of said channel locking procedure is to determine a signal type of an incoming channel.

4. The method of claim 1, wherein applying said criterion comprises determining from said interim data whether a symbol rate of a channel matches a symbol rate required by said broadband demodulator.

5. The method of claim 1, wherein applying said criterion comprises determining from said interim data whether a signal symbol spectrum picture of a channel matches a signal spectrum picture required by said broadband demodulator.

6. The method of claim 1, wherein the determining whether to continue said channel locking procedure includes using one or more selected Quadrature Amplitude Modulation checks.

7. The method of claim 1, further comprising initiating at least one channel locking procedure retry.

8. The method of claim 7, further comprising counting a number of channel locking procedure retries.

9. The method of claim 8, wherein if said number of channel locking attempts is less than a pre-selected threshold, initiating a retry command.

10. The method of claim 8, wherein if said number of channel locking attempts is greater than a selected threshold, initiating a channel locking procedure using an alternative frequency.

11. The method of claim 1, further comprising completing said channel lock procedure if said predetermined criterion for continuing said channel lock procedure has been met.

12. An apparatus comprising:
a broadband demodulator to perform a channel locking procedure, said demodulator having a channel lock sensing mechanism to determine whether to continue said channel locking procedure by applying a predetermined criterion to interim channel locking data resulting from an act of said channel locking procedure.

13. The apparatus of claim 12, wherein a controller manages operation of said lock sensing mechanism.

14. The apparatus of claim 12, further comprising a memory to store instructions to enable operation of said lock sense mechanism.

15. A cable modem device, comprising:
a controller to determine whether to continue locking onto an incoming channel by applying a predetermined criterion to interim operational data resulting from an act of said channel locking procedure; and
a demodulator to demodulate a signal received over said incoming channel.

16. The device of claim 15, wherein said controller determines from said interim data of said channel-locking procedure whether a symbol rate of a channel matches a symbol rate required by the cable modem device.

17. The device of claim 15, wherein said controller determines from said interim data of said channel-locking procedure whether a signal spectrum picture of a channel matches a signal spectrum picture required by the cable modem device.

18. An article comprising a storage medium having stored thereon instructions that, when executed by a processing platform, result in performing a channel locking procedure by a broadband demodulator; applying a predetermined criterion to interim channel locking data of said channel-locking procedure, and determining whether to continue said channel locking procedure, based on said predetermined criterion.

19. The article of claim 18, wherein applying said criterion comprises determining whether a symbol rate of a channel matches a symbol rate required by a broadband demodulator.

20. The article of claim 18, wherein applying said criterion comprises determining whether a signal symbol spectrum picture of a channel matches a signal spectrum picture required by a broadband demodulator.

21. The article of claim 18, wherein the instructions further result in completing said channel lock procedure if said predetermined criterion has been met.

22. A cable network communication system:
a cable modem termination system to broadcast signals; and
a cable modem having a demodulator adapted to screen said broadcast signals during a channel locking procedure.

23. The cable network communication system of claim 22, wherein said cable modem comprises a controller to execute instructions to screen said broadcast signals during said channel locking procedure.

24. The cable network communication system of claim 22, wherein said cable modem comprises a memory unit to store instructions to screen said broadcast signals during said channel locking procedure.

25. The cable network communication system of claim 22, wherein said cable modem rejects unwanted broadcast signals before said locking procedure is completed.
